(19) United States
(12) Patent Application Publication
(10) Pub. No.: US 2005/0050799 A1
(43) Pub. Date: Mar. 10, 2005

(54) Process for gasification of low rank carbonaceous material

(76) Inventors: Alan Stuart Buchanan, Myrrhee (AU); Roderick Howard Carnegie, Woodend (AU); John Kenneth Hamilton, East Ivanhoe (AU)

Correspondence Address: JACOBSON HOLMAN PLLC, 400 SEVENTH STREET, N.W., WASHINGTON, DC, 20004, US

(21) Appl. No.: 10/895,989

(22) Filed: Jul. 22, 2004

Related U.S. Application Data
(63) Continuation of application No. PCT/AU03/01017, filed on Aug. 12, 2003.

(30) Foreign Application Priority Data
Aug. 12, 2002 (AU) 2002950780

(51) Int. Cl. C01B 3/24

(52) U.S. Cl. 48/198.3

(57) ABSTRACT

A process for the gasification of low rank carbonaceous material, including the steps: (a) subjecting said low rank carbonaceous material to shearing stresses in order to cause attritioning of the microporous structure of said low rank carbonaceous material and release of water contained in the micropores; (b) continuing the shearing attritioning of step (a) until the low rank carbonaceous material forms into a plastic mass; (c) compacting the plastic mass of step (b) into compacted bodies; (d) heating the compacted bodies at temperatures sufficient to thermally decompose the compacted bodies to produce a reactive carbonaceous product; (e) reacting the reactive carbonaceous product with water vapour at a temperature sufficient to produce hydrogen and carbon monoxide containing gas.

### FIELD OF THE INVENTION

This invention relates generally to a process for the gasification of low rank carbonaceous material, such as brown coal, peat and/or lignite and including partially or completely anaerobically decomposed vegetative material. The invention particularly relates to a process which is suitable for the gasification of saline, low rank carbonaceous material in order to produce gas which may be used for power generation, or as a synthesis gas for hydrocarbon production.

### BACKGROUND OF THE INVENTION

Low rank carbonaceous materials, such as brown coal, peat and lignite (hereinafter collectively referred to as “brown coal”) are used extensively as fuel in thermal, electric power stations as well as for feed in the production of synthesis gases. In brown coal fuelled thermal electric power stations, the brown coal undergoes pyrolysis and combustion and the product gases are used to drive turbines for electricity generation. The gases may directly drive a gas turbine and/or be used to generate steam for driving a steam turbine.

However, such use of brown coal is problematic due to various undesirable physiochemical characteristics of many, naturally occurring brown coal deposits.

One problem is the quite high water content (usually greater than 60%) of brown coal which translates into a low conversion efficiency, and high emissions of the greenhouse gas CO₂.

Another problem is the high salt content of many brown coal deposits, especially deposits in Western and South Eastern Australia, which may have as much as 7 to 8% of dry weight of sodium chloride. At the high operating temperatures of power stations; salt is volatilised and forms products detrimental to furnace equipment. For example, sodium from the salt can react with and degrade the refractory lining of the furnace. Also, production of halide containing volatiles is also problematic. As a consequence, existing power stations are typically located on low salt containing coal seams and/or coal deposits are usually selectively mined to limit the salinity of the coal used as fuel. Clearly, this means that many brown coal deposits are not exploited to their full potential.

A still further problem of brown coal deposits is their often high mineral content which results in the production of large quantities of ash which can be difficult to remove. Ash is highly abrasive, and its presence in product gas stream is therefore detrimental to power station equipment, especially for use in gas turbines.

It is an object of the present invention to provide a process for the gasification of brown coal which overcomes, or at least alleviates, one or more of the disadvantages of the prior art.

### SUMMARY OF THE INVENTION

According to the present invention there is provided:
a process for gasification of low rank carbonaceous material, said process including the steps:
(a) subjecting said low rank carbonaceous material to shearing stresses in order to cause attritioning of the microporous structure of said low rank carbonaceous material and release of water contained in the micropores,
(b) continuing the shearing attritioning of step (a) until the low rank carbonaceous material forms into a plastic mass;
(c) compacting the plastic mass of step (b) into compacted bodies;
(d) heating the compacted bodies at temperatures sufficient to thermally decompose the compacted bodies to produce a reactive carbonaceous product;
(e) reacting the reactive carbonaceous product with water vapour at a temperature sufficient to produce hydrogen and carbon monoxide containing gas.

### DETAILED DESCRIPTION OF THE INVENTION

The low rank carbonaceous material is typically brown coal (as herein defined) but may also include other types of partially or completely anaerobically decomposed vegetative material, e.g. silage. The process is particularly suited to using saline low rank carbonaceous material, especially saline brown coal. As discussed above, such materials have previously been found to be highly problematic as feed materials for gasification reactions, because of degradation of the refractory lining in the furnace and entrainment of abrasive ash. However, using the process of the present invention, these disadvantages can be ameliorated or overcome.

The following discussion will concentrate on the use of brown coal (as herein defined) in the process of the invention, however, it is to be clearly understood that the present invention is not limited to such use and other types of low rank carbonaceous material (e.g. decomposed vegetative material, such as silage) may instead, or in addition, be used.

In step (a) of the process of the invention, the low rank carbonaceous material is subjected to shearing stresses in order to cause attritioning of the microporous structure of the material and the release of water contained in the micropores. Such shearing-attritioning is advantageously effected by feeding the material to a nip defined by two or more converging surfaces, wherein at least one of the surfaces is rollable in a direction toward the nip. Typically such shearing-attritioning takes place in a mill, preferably the mill includes at least one roller. The use of such a mill in the shearing attritioning of low rank carbonaceous material is described in detail in applicant's International Patent Application No. PCT/AU01/00062, published as WO01/54819 A1, the entire disclosure of which is incorporated herein by reference.

It is believed that the rolling action of the at least one converging surface towards said nip is advantageous because the low rank carbonaceous material, such as brown coal, is actively directed into the nip and subjected to more efficient shearing forces there than would be the case using, for example, a blending or kneading apparatus simply having rotating paddles. In such an apparatus, shearing stresses are produced in a narrow gap between the walls of the blender and the rotating paddles and are generally not as efficient as the shearing stresses generated during the process of the present invention.

The shearing attritioning may be preceded, if necessary, by a size reduction step in which the brown coal is subjected to grinding, such as in a hammer mill.

The shearing attritioning is preferably effected in a rotating roll type pelletising mill. Such a mill typically comprises a housing, preferably drum or cylindrical in shape, within which is provided at least one rollable curved surface, typically the surface of a roll, preferably a cylindrical shaped roll. The curved inner surface of the housing and the curved surface of, for example, the roll are positioned relative to each other so as to provide two converging surfaces between which is defined a nip. This typically will require that the axis of rotation of the roll will be eccentric relative to the axis of rotation of the housing. In use, there is relative rotational movement between the two surfaces. This may be effected by rotation of the housing about its axis and/or rotation of the roll about its axis. Alternatively, the housing may be stationary and the roll rotates about the axis of the housing as well as rotating about its own axis. The rotation of the roll about the axis of the housing may be effected by means of an arm mounted for rotatable movement at the axis of the housing, and having at one end thereof the roll also mounted for rotatable movement. The relative rotational movement of the two surfaces is such as to cause the brown coal to be forced into the nip, where it is subjected to shearing attritioning.

In one preferred embodiment of the invention, an arm is mounted for rotatable movement at the axis of the housing and a roll is mounted at either end of the arm. In such an arrangement the mill has in effect two pairs of converging surfaces, with each roll providing a rollable surface defining a nip where the rollable surface is closest to the inner surface of the housing.

It is believed that the shearing attritioning of the coal particles causes breakage of bonds between coal particles with consequential release of water trapped in micropores of the coal structure.

In step (b), the shearing attritioning is continued until the low rank carbonaceous material forms into a wet plastic mass.

In step (c), the plastic mass is compacted to form compacted bodies. Preferably, compaction is effected by extrusion. Typically the extrusion occurs substantially immediately after or concurrently with the shearing attritioning. The extrusion further shears the material. Most preferably the shearing attritioning and extrusion occur in a single operation, typically in a single apparatus, which avoids the need to transfer the material from an attritioning apparatus to an extruder. The extrusion is advantageously effected by forcing the attritioned material through tapered apertures, having decreasing diameter as the material is pushed through. The tapered apertures effect the application of very high pressures to the material during extrusion, causing further mechanical release of water from the micropores of the brown coal and forcing the coal particles into close proximity thereby promoting renewed bonding between the particles. The apertures typically have a diameter ranging from about 8 to about 20 mm, preferably about 8 to about 15 mm, more preferably from about 10 to about 12 mm. The length of the apertures typically range from about 15 to about 100 mm, preferably from about 30 to about 90 mm, more preferably from about 30 to about 60 mm.

In another type of rotating roll type pelletising mill, one or more rollable curved surfaces are positioned closely adjacent a substantially planar surface, with each rollable curved surface together with the planar surface defining a nip therebetween. The rollable curved surface is typically the surface of a cylindrical shaped roll. Preferably, the axis of rotation of each roll is essentially parallel with the planar surface. Typically the or each cylindrical roll is positioned for rotatable movement closely above the planar surface. The or each rotatable roll may additionally be mounted for rotatable movement about an axis perpendicular to the planar surface. The attritioned brown coal is then subjected to extrusion by being forced through apertures in a die, the upper surface of which forms the planar surface. Cylinders of extruded brown coal exit the other side of the die where they are cut into pellets.

The inventors have found that rotating roll type pelletising mills, which are commonly used in the production of pelleted animal feed, fertilisers and pharmaceuticals, or in the densification of dusty materials, are suitable for use in the process of the invention. For example, suitable machines are those sold by the company Sprout Waldron & Company, Inc. in Muncy, Pa. 17745, United States of America, such as the pellet mill having the trade name Sprout Waldron Junior Ace, and those sold by California Pellet Mill. Further, suitable machines also include flat die pelleting presses, such as those sold by Amandus Kahl GmbH & Co.

In using a rotating roll type pelletising mill, such as the Sprout Waldron pelleting mills, the brown coal is subjected to shearing attritioning at the nip between the surface of each roll and another surface in the mill. That other surface also forms part of an extruder die, having holes through which the attritioned brown coal is extruded. Accordingly, simultaneously with the shearing attritioning at each nip, the attritioned brown coal is forced through the holes of the die by the action of the roll. The attritioned brown coal is thereby compressed into solid cylinders which are cut into pellets as they emerge by cut-off knives. The combined operations of shearing, attritioning and extrusion occur in a very short time period (e.g. fractions of a second), thus avoiding lengthy time periods which would otherwise be required to first form an extrudable paste and then transfer the paste to an extruder from which pellets are produced.

In the Sprout Waldron pelletising mill, shearing attritioning occurs at the nip between the surface of each roll and the inner wall of the rotating housing. The housing is also an extruder die having tapered holes therethrough with decreasing diameter from the inner wall to the outer wall. Tapered holes ensure the application of very high pressures to the material during extrusion. A rotatable arm is mounted for rotatable movement about the axis of the housing and a roll is mounted for rotatable movement at each end of the arm. The rotatable arm is typically powered by a 50 hp motor. The diameter of the tapered holes in the die can be as small as 10 to 12 mm. It will therefore be appreciated that an extremely efficient shearing force is exerted on the brown coal at the nip and that it is subjected to very high pressure as it is forced through the tapered holes, thereby forcing the coal particles into very close proximity with each other. Accordingly, water loss from the microstructure and renewed bonding between coal particles is maximised. The act of extrusion also substantially increases the temperature of the emerging pellets, which may be as high as 50° C. Such a high temperature enhances evaporation of surficial water from the pellets released from the micropores. This feature of the process of the invention is extremely advantageous since it ensures substantial water loss from the pellets in the very early stage of the drying process, thereby considerably minimising the overall drying time.

In some circumstances, pelletising machines sold by Warren & Baerg Manufacturing Inc., such as the Model 250 Cuber, may be used. However due to the less effective shearing action of this machine, it may be necessary to additionally use a further attritioner and/or extruder in combination with it.

The compacted bodies are preferably allowed to air dry before being heated in step (d). The air dried bodies typically contain around 12% total water, plus carbon, volatiles and minerals derived from the original brown coal.

In step (d), the compacted bodies are heated to a temperature sufficiently high to thermally decompose them and produce a reactive carbonaceous product. As the bodies are heated, initially, water vapour and small amounts of organic volatiles, such as phenols, are typically produced at temperatures in the range from 200 to 450° C. When the temperature reaches 500° C., methane, hydrogen and carbon monoxide are generally the dominant gases, with smaller amounts of carbon dioxide and other hydrocarbons.

As the temperature is further increased to 750 to 800° C., hydrogen and carbon monoxide increase in volume, while methane decreases. Generally, hydrogen is the most important gaseous component generated below 850° C., whereas carbon monoxide becomes more important above 850° C.

Heat required for thermal decomposition in step (d) is typically initially provided by an external heat source, such as a gas flame or electric heating means. However, once thermal decomposition has commenced, the external heat source can be turned off or removed, since injected air can react with the combustible gases given off the compacted bodies in order to provide the heat for pyrolysis. In this way, the reaction in step (d) can be substantially self-sustaining. Moreover, due to the highly reactive nature of the brown coal in the compacted bodies, the pyrolysis proceeds at a significantly lower temperature than prior art pyrolysis of brown coal. This is extremely advantageous in the case of pyrolysing saline brown coal, because the temperature of pyrolysis is lower than the boiling temperature of NaCl (i.e. 1413° C.). This means that NaCl (and other salts of similar boiling point) are not volatilised during pyrolysis and therefore do not react with the refractory lining of the furnace causing degradation.

Following thermal decomposition of the compacted bodies, a highly reactive carbonaceous phase (typically char) remains, together with ash derived from the minerals in the original brown coal. This phase is preferably transferred from the pyrolysis furnace to a reactor for carrying out step (e).

The char is then reacted with water vapour in step (e). The reaction takes place at a temperature sufficient to produce hydrogen and carbon monoxide containing gas. Heat is typically provided by the hot char and the hot, partially combusted gases derived from pyrolysis in step (d).

Given the high reactivity of the char, largely due to its very high surface area, the conversion to hydrogen and carbon monoxide usually occurs very rapidly within the temperature range 700 to 800° C. This is considerably lower than gasification temperatures of the prior art processes. Again, the lower temperature confers an advantage in that removal of ash from the product gas stream is simplified. The temperature of the product gas stream is low enough to be treated with conventional particle removal techniques, such as by passing through a conventional cyclone, before the gas stream is fed to a turbine. With conventional gasification processes, the much higher temperature of the gasification reaction means that conventional equipment cannot be used to remove ash due to the risk of high temperature damage to the equipment, such as melting.

The char conversion occurs in the temperature range from approximately 700 to 800° C., which is below the melting point of NaCl, i.e. 801° C. This means that there is very little or no molten NaCl produced. However, even if the furnace temperature does exceed 801° C., the typically high quantities of siliceous ash resulting from pyrolysis of saline brown coal are able to entrain any molten sodium chloride present. Accordingly, a solid phase is formed from reaction of siliceous ash with molten sodium chloride, which solid phase does not react with water vapour during char conversion.

Steps (d) and (e) of the invention may be combined into a single stage, such as where the initial pyrolysis and subsequent water gas reaction takes place simultaneously in a combined reactor. However, the product gas stream is likely to contain greater amounts of nitrogen if the air for combustion is injected at the same time as steam for gasification. Accordingly, such product gases are likely to have a lower calorific value than a product gas from a two stage reactor where steam injection is conducted separately from air injection.

For this reason, and for the reason of greater control of operating conditions, it is preferred that process steps (d) and (e) are conducted in two separate stages.

It has been found that the gas produced from step (e) of the invention typically has a composition in which the ratio of H₂:CO is close to the desired value of 1:1. This gas may subsequently be used directly in a gas-turbine for power generation. Moreover, the relatively low temperature of the gas facilitates removal of entrained ash, thereby minimising any abrasive damage to the turbine. Alternatively, the product gas may be used as fuel for a boiler to produce steam for operating a steam turbine. Another possible use for the product gas is as a synthesis gas for hydrocarbon production.

### EXAMPLES

Saline brown coal from the Loy Yang coal mine in the Latrobe Valley, Victoria, Australia and having 60% by weight water as mined was subjected to shearing attritioning and extrusion in a Sprout-Waldron Junior Ace pelleting mill. The wet pellets had a diameter of about 12 mm when formed. These pellets were allowed to air dry under ambient conditions with a maximum day temperature of between 26 and 28° C. The water content of the pellets had decreased to about 17.5 wt % after 20 hours of air drying. The final dried pellets had about 16% total water plus carbon, volatiles and minerals including sodium chloride.

The concentration of sodium chloride in the dried pellets was a maximum of 7 to 8% of the dry weight of the pellets.

The dried pellets were then fed to a small rotary furnace that was heated indirectly (electrically). As the furnace temperature was increased, water vapour, and organic volatiles were produced from about 200° C. The volatiles ignited around 420° C. and the furnace temperature increased to a maximum temperature from around 700 to 850° C. The pellets were then held at the maximum temperature for approximately 20 minutes in order to produce char.

The average maximum temperature was around 800° C. The pyrolysed pellets exhibited a surface area of between approximately 320 and 410 m²/gram, a carbon content of between about 75 and 90 wt % and a weight loss on processing of from about 35 to 45 wt %.

The hot char produced by pyrolysis of the pellets was then able to be reacted with steam in order to produce a gas product including hydrogen and carbon monoxide. The gasification reaction preferably takes place in a separate reactor, such as a second furnace. More preferably, the gasification reaction takes place in a moving bed reactor. The temperature of the second furnace is preferably in the range of about 700 to 800° C. The hot pellets are charged to the reactor, typically via a conveyor, with no or minimal cooling first. Steam is then injected into the reactor for a period of time sufficient to convert substantially all of the char to a gas containing CO and H₂ as well as possibly other hydrocarbons. The gasification reaction substantially takes place at a temperature in the range of about 700 to 800° C. Typically little or no molten NaCl is produced during gasification. However, any molten NaCl which is produced is typically entrained by siliceous ash produced during the pyrolysis process. The resultant phase does not react with water vapour during gasification and thereby avoids damage to equipment due to production of chloride containing gases.

The resultant CO and H₂ containing gas stream may be used for a gas turbine or a steam turbine, or as a synthesis gas for manufacture of hydrocarbons.

Further, it is to be understood that various alterations, modifications and/or additions may be introduced into the constructions and arrangements of steps previously described without departing from the spirit or ambit of the invention.

1-15. (canceled).

16. A process for the gasification of low rank carbonaceous material, including the steps:
(a) subjecting said low rank carbonaceous material to shearing stresses in order to cause attritioning of the microporous structure of low rank carbonaceous material and release of water contained in the micropores;
(b) continuing the shearing attritioning of step (a) until the low rank carbonaceous material forms into a plastic mass;
(c) compacting the plastic mass of step (b) into compacted bodies;
(d) heating the compacted bodies at temperatures sufficient to thermally decompose the compacted bodies to produce a reactive carbonaceous product;
(e) reacting the reactive carbonaceous product with water vapour at a temperature sufficient to produce hydrogen and carbon monoxide containing gas.

17. The process of claim 16, wherein said low rank carbonaceous material is one or more of brown coal (as herein defined) or partially or completely decomposed vegetative material.

18. The process of claim 16, wherein the low rank carbonaceous material is a saline low rank carbonaceous material, preferably saline brown coal.

19. The process of claim 16 wherein the shearing attritioning takes place in a rotating roll type pelletising mill.

20. The process of claim 16, wherein, in step (c), compaction of the plastic mass is effected by extrusion, preferably through tapered apertures.

21. The process of claim 5, wherein said extrusion occurs substantially immediately after or concurrently with the shearing attritioning.

22. The process of claim 16, wherein in step (d), the compacted bodies are initially heated using an external heat source until thermal decomposition commences and thereafter the external heat source is removed and heating is provided by reaction of air with combustion gases produced by said thermal decomposition.

23. The process of claim 16, wherein the thermal decomposition of the compacted bodies substantially takes place at temperatures lower than the boiling point of NaCl (1413° C.).

24. The process of claim 16, wherein the reaction between said carbonaceous product and water vapour in step (e) takes place at a temperature in the range of approximately 700 to 800° C.

25. The process of claim 16, wherein the hydrogen and carbon monoxide containing gas stream produced in step (e) is treated with conventional particle removal techniques, such as by passing through a conventional cyclone, without cooling, in order to remove any unwanted particulate material such as ash.

26. The process of claim 25, wherein said treated gas stream is used directly in a gas turbine for power generation.

27. The process of claim 25, wherein said treated gas stream is used as a fuel for a boiler to produce steam for generating a steam turbine.

28. The process of claim 25, wherein said treated gas stream is used as a synthesis gas for hydrocarbon production.

29. The process of claim 16, wherein steps (d) and (e) are conducted separately.
